(19) United States
(12) Patent Application Publication
(10) Pub. No.: US 2007/0050342 A1
(43) Pub. Date: Mar. 1, 2007

(54) REAL ESTATE LISTING AND ADVERTISING SYSTEM

(76) Inventors: Sami Inkinen, San Francisco, CA (US); Peter Flint, San Francisco, CA (US)

Correspondence Address: PERKINS COIE LLP, P.O. BOX 2168, MENLO PARK, CA, 94026, US

(21) Appl. No.: 11/465,111

(22) Filed: Aug. 16, 2006

Related U.S. Application Data
(60) Provisional application No. 60/708,842, filed on Aug. 16, 2005.

(51) Int. Cl. G06F 17/30

(52) U.S. Cl. 707/3

(57) ABSTRACT

In an embodiment, a method is provided. The method includes receiving real estate listings by submission at a website. Also, the method includes receiving a search query from a user at a user website. Further, the method includes presenting real estate listings responsive to the search query on the user website.

### CLAIM OF PRIORITY

This application claims priority to U.S. Provisional Patent Application No. 60/708,842, filed on Aug. 16, 2005, which is hereby incorporated herein by reference.

### BACKGROUND

Residential real estate markets are relatively inefficient. A buyer may do months of research before making the decision to seriously look for a house. During that time, the buyer may look at many listings for properties, and submit identifying information on the Internet to get access to such listings. All of these submissions from a buyer not ready to buy are low value leads to the real estate agent attempting to complete a transaction.

FIG. 1 illustrates an embodiment of a network of real estate websites and agents. System 100 involves a group of websites and real estate entities common in the marketplace. An agent 110 typically receives a listing for a house or similar property. The agent may then place that listing with an associated agency 120, getting some benefit of resources from the agency 120 in return for the association. The agent is also likely to list the listing with a multiple listing service (MLS) 130. This may be done automatically by the agency 120.

The MLS 130 may have a MLS website 140 at which such listings are accessible. In some instances, the MLS website 140 may or may not offer all information on the listing over the internet For example, a typical MLS listing includes information about how long the listing has been on the market, what the asking price is, and the size of the house. However, the asking price and size of the house may be accessible in a public listing over the internet while the time on the market may be excluded from all but paying MLS 130 customers.

Agency 120 may also have its own agency website 150. An agency website 150 typically provides listings only from the agency 120 itself. Moreover, the agency 120 may also have a relationship with a search engine or portal, allowing for access to listings through the portal at a search site 160. Finally, the agent 110 may have a personal website 170 where the agents 110 personal listings may be accessed.

Thus, a listing may be available in a multitude of places on the web. However, none of these websites are likely to provide a lot of value added content. Moreover, each is in some way affiliated with the agent 110 and/or the agency 120. This is not unreasonable, as the agent is attempting to get a wide audience for the listing. However, a casual user may need to search for all potential agents or agencies within a geographical market to see all listings. Alternatively, limited information may be available from the MLS website 140. Thus, a centralized collection of real estate data may be advantageous.

Additionally, an opportunity to advertise is often denied to the overall market on most of these sites. For example, a competing agent or a buyer's agent typically cannot advertise on an agent's site 170 or an agency site 150. While this is understandable, it means that market participants may not get the benefit of available resources (either agents with time to help buyers or buyers needing a buyer's agent). Thus, it may be useful to provide an opportunity to advertise services along with real estate listings.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 illustrates an embodiment of a network of real estate websites and agents.

FIG. 2 illustrates an embodiment of a real estate portal and related connections.

FIG. 3 illustrates an embodiment of a method of operating a real estate portal.

FIG. 4 illustrates an alternate embodiment of a method of operating a real estate portal.

FIG. 5 illustrates an alternate embodiment of a real estate portal and related connections.

FIG. 6 illustrates another embodiment of a method of operating a real estate portal.

FIG. 7 illustrates an embodiment of a network which may be used in conjunction with various real estate portals.

FIG. 8 illustrates an embodiment of a computer or machine which may be used in conjunction with various real estate portals.

FIG. 9 illustrates an embodiment of a medium embodying modules of a real estate portal.

FIG. 10 illustrates an embodiment of a method of operating advertising on a real estate portal.

FIG. 11 illustrates an embodiment of a search page of a real estate portal.

FIG. 12 illustrates an alternate embodiment of a search page of a real estate portal.

FIGS. 13A and 13B illustrate an embodiment of a display of property search results.

FIGS. 14A and 14B illustrate an embodiment of a display of single property information.

FIG. 15 illustrates another embodiment of a search page of a real estate portal.

FIG. 16 illustrates another alternate embodiment of a search page of a real estate portal.

FIGS. 17A and 17B illustrate another embodiment of a display of property search results.

FIG. 18A and 18B illustrate another embodiment of a display of single property information.

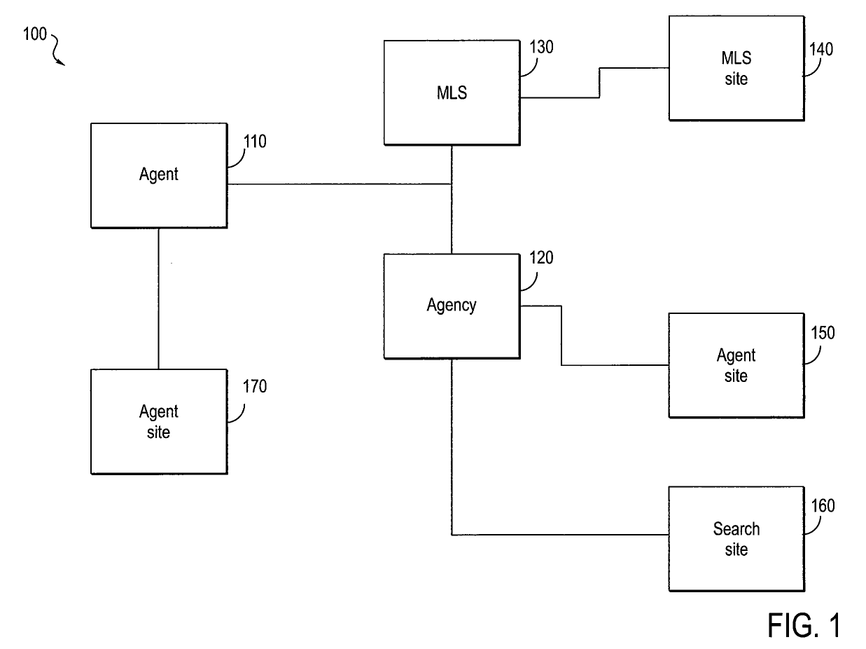

### DETAILED DESCRIPTION

A system, method and apparatus is provided for a real estate listing and advertising system or real estate portal. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In an embodiment, a real estate portal is provided. The portal includes an interface useful to obtain real estate listings. The interface may include a crawler-style robot which traverses the web to find real estate listings, either at known real estate sites or sites discovered by the crawler. The interface may also include a submissions interface which accepts listings from real estate agents, real estate agencies, multiple listing services, and owners of real estate. The portal may also include an advertising interface which accepts advertising submissions from service providers (such as real estate agents or agencies). The portal may then store data in a database and provide that data to users on demand.

In an embodiment, a method is provided. The method includes receiving real estate listings by submission at a website. The method further includes searching for real estate listings on the world wide web. The method also includes receiving a search query from a user at a user website. The method additionally includes presenting real estate listings responsive to the search query on the user website. The method and other methods may include receiving advertising submissions at a website and presenting advertising submissions related to the search query on the user website.

In another embodiment, a method is presented. The method includes receiving real estate listings by submission at a website. Also, the method includes searching for real estate listings on the world wide web. Additionally, the method includes receiving real estate listings through a feed. Moreover, the method includes receiving a search query from a user at a user website. Furthermore, the method includes presenting real estate listings responsive to the search query on the user website.

In yet another embodiment, a system is provided. The system includes a computer. The computer has a network interface. The computer has a user interface. The computer is to receive real estate listings by submission at a website. The computer is further to search for real estate listings on the world wide web. The computer is to receive a search query from a user at a user website. The computer is also to present real estate listings responsive to the search query on the user website.

In still another embodiment, a method is provided. The method includes receiving real estate listings through a feed. The method further includes receiving a search query from a user at a user website. The method also includes presenting real estate listings responsive to the search query on the user website.

In another embodiment, a method is provided. The method includes receiving real estate listings by submission at a website. Also, the method includes receiving a search query from a user at a user website. Further, the method includes presenting real estate listings responsive to the search query on the user website.

In yet another embodiment, a machine-readable medium embodying instructions is provided. The instructions, when executed by a processor, cause the processor to implement a method. The method includes receiving real estate listings by submission at a website. The method further includes receiving real estate listings through a feed. The method additionally includes searching for real estate listings on the world wide web. The method also includes receiving a search query from a user at a user website. The method includes presenting real estate listings responsive to the search query on the user website.

In a further embodiment, a method is provided. The method includes searching for real estate listings on the world wide web. The method also includes receiving a search query from a user at a user website. The method further includes presenting real estate listings responsive to the search query on the user website.

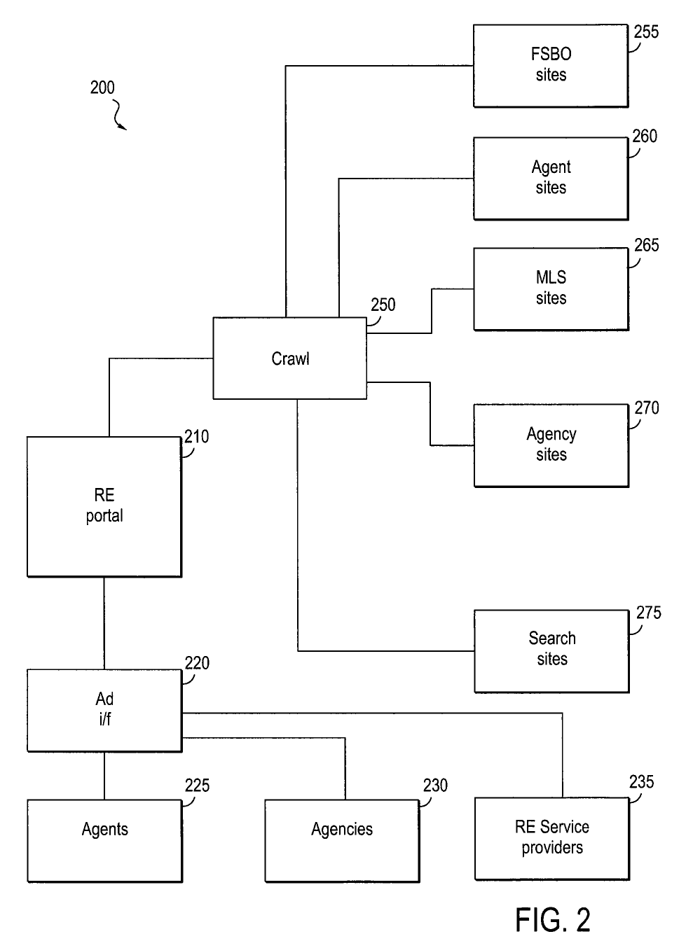

FIG. 2 illustrates an embodiment of a real estate portal and related connections. System 200 represents the portal 210, associated interfaces, and the sources of information or submissions. Crawler 250 is a robotic website crawler which traverses the web seeking information on real estate listings. FSBO (for sale by owner) sites 255, agent sites 260, MLS sites 265, agency sites 270 and search engine sites 275 all represent sources of data which may provide listings of properties useful to a real estate portal. Other sources of data may also be used or accessed, such as newspaper sites, listing sites, foreclosure sites, and similar sites listing real estate information.

Crawler 250 may find and scrape all of this data, submitting it to a database for storage, for example. Preferably, crawler 250 adheres to a robots exclusion standard to enable publishers to limit access and exposure of content to automated crawlers. Moreover, crawler 250 may obtain data from one website about a listing, and additional data about the same listing from another website, and submit all of this data to a database where the data is then aggregated into a more complete picture of the listing.

Advertising interface 220 allows for submission of advertising to the website. Banner ads may be acceptable in some embodiments. However, cost-per-click advertising may also be useful. Advertisements may come from sources such as agents 225, agencies 230 and real estate service providers 235 (such as title insurance companies, mortgage providers or appraisers, for example).

Paid advertisements on a cost-per-click basis may be highly valued under some conditions. Setting the conditions and allowing for an auction of the cost-per-click advertising space may thus efficiently allocate advertising and potentially maximize revenue from such a model. Thus, advertising may be specified for a geographic area, a minimum or maximum size (square feet or bedrooms for example), asking price, type of property (standalone or detached house, condominium, townhome for example), and other features. Moreover, a combination of such features may be used, such that a bidder may specify a bid for listings of properties in Palo Alto, California with a minimum asking price of $1,000,000 for example. A different real estate agent may specify a bid for listings in Sanger, Calif. with a minimum asking price of $300,000 for example.

If multiple bidders have overlapping conditions, then the high bidder wins the auction for the listing, and has its advertisement and referral link displayed along with listings meeting the specified conditions. Note that for each listing, the conditions of a variety of bids may match, and all bids may then be evaluated to determine which bid or bids wins. Moreover, some bids may condition the bid on which position in the paid advertising space of a portal is available, with (typically) higher bids for a first position and lower bids for a second or third position. Alternatively, high bidders may automatically get a first position, with runner up bids getting a second position, for example.

Portal 210 presents the information gathered by crawler 250 along with advertisements from advertising interface 220. In some embodiments, portal 210 provides a searchable database of information as found by crawler 250. In other embodiments, portal 210 provides a browseable interface, with real estate information organized by common categories such as city, zip (postal) code, price, or other features.

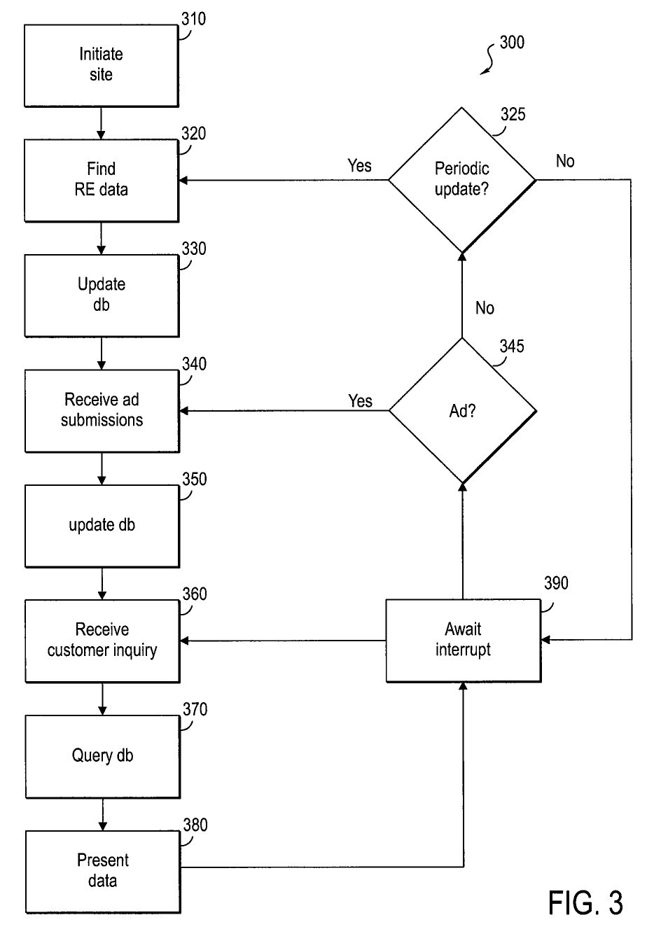

Operation of a portal such as portal 210 may occur through a variety of different methods. FIG. 3 illustrates an embodiment of a method of operating a real estate portal. Method 300 includes initiating a site, finding real estate data (listings), receiving advertising submissions, updating a database, receiving a customer inquiry, querying the database, and presenting data to the customer.

Method 300 and other methods of this document are composed of modules which may be rearranged into parallel or serial configurations, and may be subdivided or combined. The method may include additional or different modules, and the modules may be reorganized to achieve the same result, too.

Method 300 begins with initiation the website at module 310. This may be as simple as putting up a relatively simple website with initial data seeded into a database. At module 320, real estate data is found, such as by crawling the web or internet with a crawler to find data from various websites. The resulting data populates a database at module 330. At module 340, advertising submission are received, such as from agents or agencies, for example. At module 350, the real estate database is also updated with this information. At module 360, a customer inquires about real estate, such as through a search. This search may generate a query to the database at module 370, with results of that query used to display data to the user at module 380. Thus, the user may see listings based on criteria such as location, size of house, listing price, or other criteria for example.

At module 390, the website awaits further action. This may result in receipt of another customer inquiry at module 360. Alternatively, an advertisement may be detected at module 345, or a periodic crawl of the web may be indicated at module 325. Thus, the website may continue to operate, accepting customer requests or advertising and periodically surveying the internet for further information.

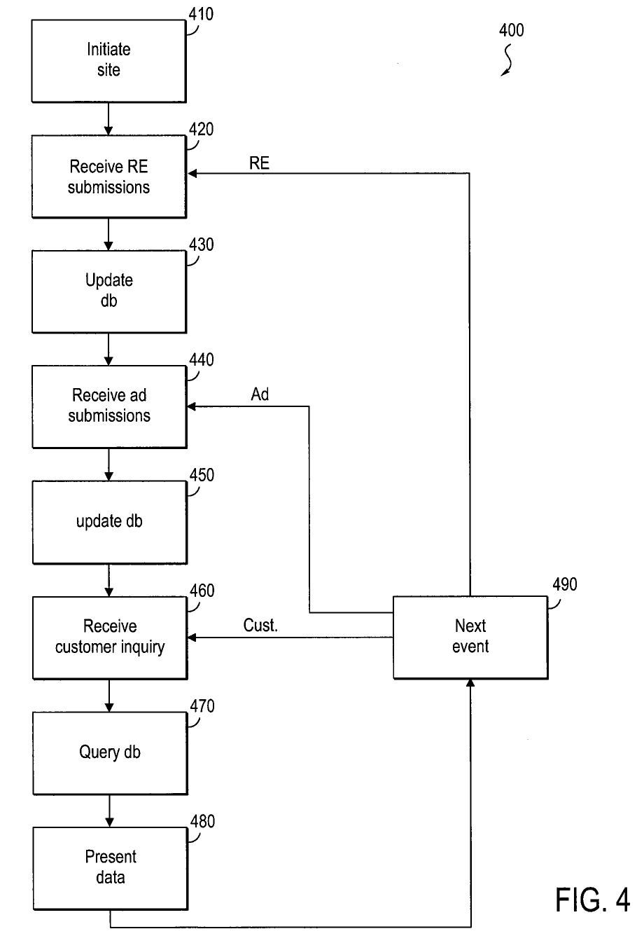

Alternatively, a website may operate based on submission of listings. FIG. 4 illustrates an alternate embodiment of a method of operating a real estate portal. Method 400 includes initiating a site, receiving real estate data (listings), receiving advertising submissions, updating a database, receiving a customer inquiry, querying the database, and presenting data to the customer.

Method 400 begins with initiation of the website at module 410. At module 420, real estate data is submitted, such as from an agent or agency. The submissions may also come from an owner of a property or an aggregator of data, for example. The resulting listing data populates a database at module 430. At module 440, advertising submission are received, such as from agents or agencies, for example. At module 450, the real estate database is updated with this information. At module 460, a customer generates an inquiry about real estate, such as through a search. This search may generate a query to the database at module 470, and results of that query may be used to display data to the user at module 480. Thus, the user may see listings based on criteria such as location, size of house, listing price, or other criteria for example.

At module 490, the website awaits the next event. This may result in receipt of another customer inquiry. Alternatively, an advertisement may be detected, or a real estate listing submission may occur. Thus, the website may continue to operate, accepting customer requests, advertising or listing information.

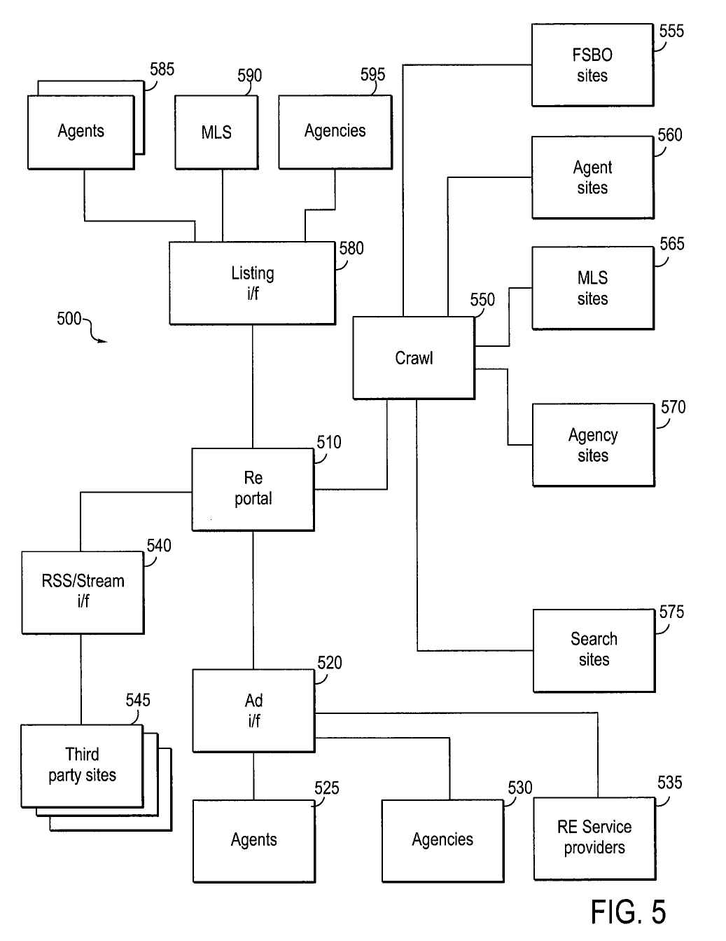

With submissions, an alternative portal structure may be useful, too. FIG. 5 illustrates an alternate embodiment of a real estate portal and related connections. System 500 represents the portal 510, associated interfaces, and the sources of listings.

Advertising interface 520 allows for submission of advertising to the website. Banner ads may be acceptable in some embodiments. However, cost-per-click advertising may also be useful. Advertisements may come from sources such as agents 525, agencies 530 and real estate service providers 535 (such as title insurance companies, mortgage providers or appraisers, for example).

Real estate listing information may come from a submission or listing interface 580, or a crawler 550. Listing interface 580 may accept submissions from a variety of source, whether as single listings or as a number of listings in a batch form, for example. Listings may come from, among others, agents 585, MLS groups 590, and real estate agencies 595, for example.

Crawler 550 is a robotic website crawler which traverses the web seeking information on real estate listings. FSBO (for sale by owner) sites 555, agent sites 560, MLS sites 565, agency sites 570 and search engine sites 575 all represent sources of data which may provide listings of properties useful to a real estate portal.

Crawler 550 may find and scrape all of this data, submitting it to a database for storage, for example. Also, crawler 550 may receive data from one website about a listing, and additional data about the same listing from another website, and submit all of this data to a database where the data is then aggregated into a single listing. Preferably, crawler 550 adheres to a robot standard protocol to avoid treading on the intellectual property and proprietary content of others while accessing as much data as possible.

Portal 510 presents the information gathered by crawler 550 along with advertisements from advertising interface 520. In some embodiments, portal 510 provides a searchable database of information as found by crawler 550. In other embodiments, portal 510 provides a browseable interface, with real estate information organized by common categories such as city, zip (postal) code, price, or other features. This content may also be provided to other third party websites 545 through RSS/stream interface 540. Interface 540 provides data which may be used in an RSS or HTML streaming or distribution process, thereby allowing for third-party display of such information. Such third-party display may be monetized in commercial relationships in some embodiments or instances.

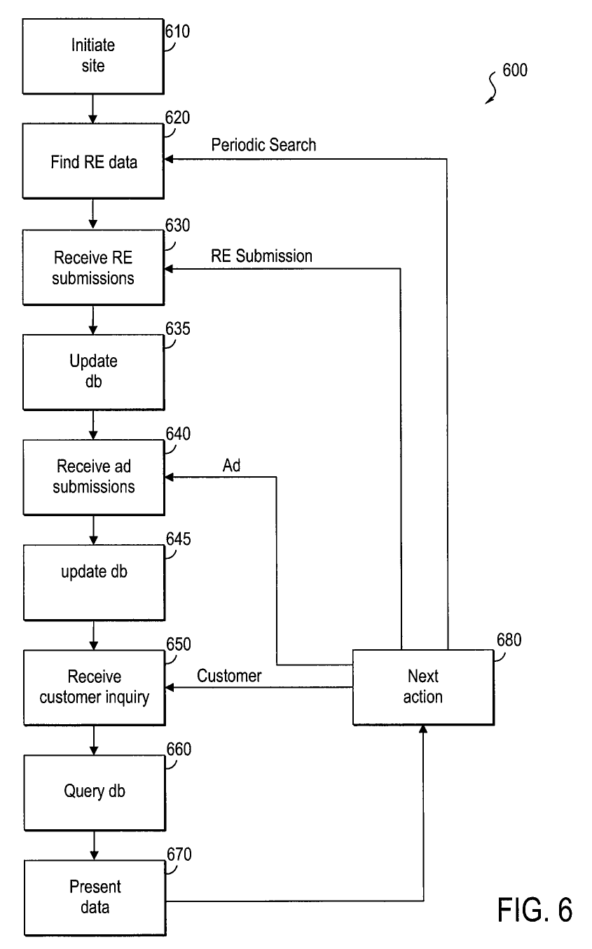

As one may expect, an alternative method of operating a real estate portal may apply where both real estate submission and independent crawling are involved. FIG. 6 illustrates another embodiment of a method of operating a real estate portal. Method 600 includes initiating a site, finding real estate data (crawling), receiving real estate data (submissions), receiving advertising submissions, updating a database, receiving a customer inquiry, querying the database, and presenting data to the customer.

Method 600 begins with initiation of the website at module 610. At module 620, real estate data is found, such as by crawling the web or internet with a crawler to find data from various websites. At module 630, real estate data is submitted, such as from an agent or agency for example. The resulting listing data (submitted or found) populates a database at module 635. At module 640, advertising submission are received, such as from agents or agencies, for example. The real estate database is updated with this information at module 645. At module 650, a customer generates an inquiry about real estate, such as through a search. This search may generate a resulting query to the database at module 660, and results of that query may be used to display data to the user at module 670.

At module 680, the website awaits the next event. This may result in receipt of another customer inquiry. Alternatively, an advertisement may be detected, or a real estate listing submission may occur. Similarly, a periodic crawl time period may be detected, and a crawl of the web initiated. Thus, the website may continue to operate, accepting customer requests, advertising or listing information

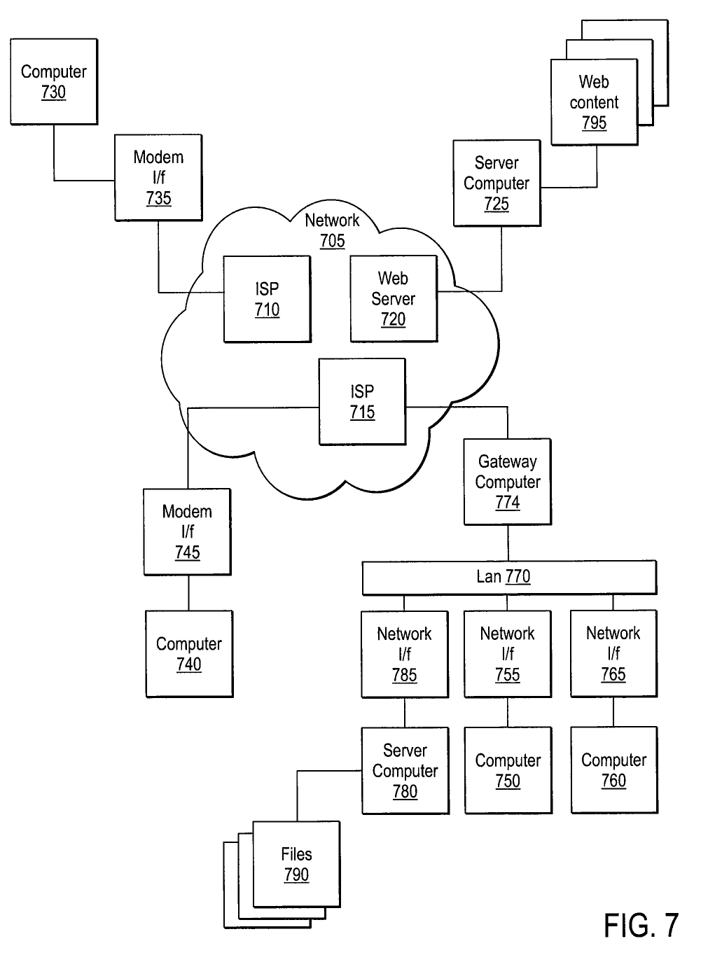

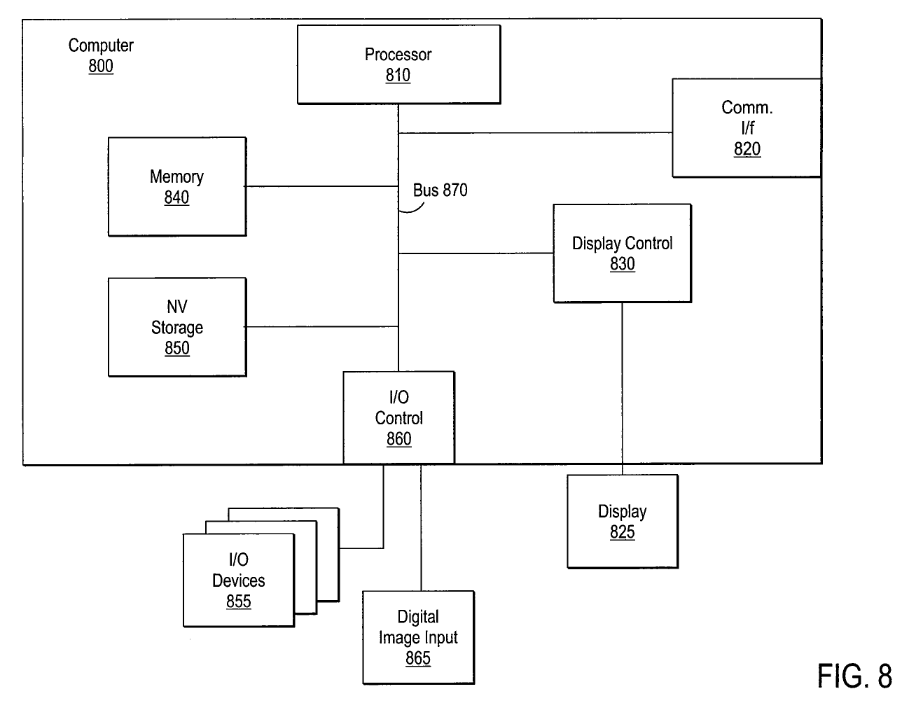

The following description of FIGS. 7-8 is intended to provide an overview of computer hardware and other operating components suitable for performing the methods of the invention described above and hereafter, but is not intended to limit the applicable environments. Similarly, the computer hardware and other operating components may be suitable as part of the apparatuses of the invention described above. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 shows several computer systems that are coupled together through a network 705, such as the internet The term “internet” as used herein refers to a network of networks which uses certain protocols, such as the tcp/ip protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 705 is typically provided by internet service providers (ISP), such as the ISPs 710 and 715. Users on client systems, such as client computer systems 730, 740, 750, and 760 obtain access to the internet through the internet service providers, such as ISPs 710 and 715. Access to the internet allows users of the client computer systems to exchange information, receive and send e-mails, and view documents, such as documents which have been prepared in the HTML format. These documents are often provided by web servers, such as web server 720 which is considered to be “on” the internet. Often these web servers are provided by the ISPs, such as ISP 710, although a computer system can be set up and connected to the internet without that system also being an ISP.

The web server 720 is typically at least one computer system which operates as a server computer system and is configured to operate with the protocols of the world wide web and is coupled to the internet. Optionally, the web server 720 can be part of an ISP which provides access to the internet for client systems. The web server 720 is shown coupled to the server computer system 725 which itself is coupled to web content 795, which can be considered a form of a media database. While two computer systems 720 and 725 are shown in FIG. 7, the web server system 720 and the server computer system 725 can be one computer system having different software components providing the web server functionality and the server functionality provided by the server computer system 725 which will be described further below.

Client computer systems 730, 740, 750, and 760 can each, with the appropriate web browsing software, view HTML pages provided by the web server 720. The ISP 710 provides internet connectivity to the client computer system 730 through the modem interface 735 which can be considered part of the client computer system 730. The client computer system can be a personal computer system, a network computer, a web tv system, or other such computer system.

Similarly, the ISP 715 provides internet connectivity for client systems 740, 750, and 760, although as shown in FIG. 7, the connections are not the same for these three computer systems. Client computer system 740 is coupled through a modem interface 745 while client computer systems 750 and 760 are part of a LAN. While FIG. 7 shows the interfaces 735 and 745 as generically as a “modem,” each of these interfaces can be an analog modem, isdn modem, cable modem, satellite transmission interface (e.g. “direct PC”), or other interfaces for coupling a computer system to other computer systems.

Client computer systems 750 and 760 are coupled to a LAN 770 through network interfaces 755 and 765, which can be ethernet network or other network interfaces. The LAN 770 is also coupled to a gateway computer system 775 which can provide firewall and other internet related services for the local area network. This gateway computer system 775 is coupled to the ISP 715 to provide internet connectivity to the client computer systems 750 and 760. The gateway computer system 775 can be a conventional server computer system. Also, the web server system 720 can be a conventional server computer system.

Alternatively, a server computer system 780 can be directly coupled to the LAN 770 through a network interface 785 to provide files 790 and other services to the clients 750, 760, without the need to connect to the internet through the gateway system 775.

FIG. 8 shows one example of a conventional computer system that can be used as a client computer system or a server computer system or as a web server system. Such a computer system can be used to perform many of the functions of an internet service provider, such as ISP 710. The computer system 800 interfaces to external systems through the modem or network interface 820. It will be appreciated that the modem or network interface 820 can be considered to be part of the computer system 800. This interface 820 can be an analog modem, isdn modem, cable modem, token ring interface, satellite transmission interface (e.g. “direct PC”), or other interfaces for coupling a computer system to other computer systems.

The computer system 800 includes a processor 810, which can be a conventional microprocessor such as an Intel pentium microprocessor or Motorola power PC microprocessor. Memory 840 is coupled to the processor 810 by a bus 870. Memory 840 can be dynamic random access memory (dram) and can also include static ram (sram). The bus 870 couples the processor 810 to the memory 840, also to non-volatile storage 850, to display controller 830, and to the input/output (I/O) controller 860.

The display controller 830 controls in the conventional manner a display on a display device 835 which can be a cathode ray tube (CRT) or liquid crystal display (LCD). The input/output devices 855 can include a keyboard, disk drives, printers, a scanner, and other input and output devices, including a mouse or other pointing device. The display controller 830 and the I/O controller 860 can be implemented with conventional well known technology. A digital image input device 865 can be a digital camera which is coupled to an i/o controller 860 in order to allow images from the digital camera to be input into the computer system 800.

The non-volatile storage 850 is often a magnetic hard disk, an optical disk, or another form of storage for large amounts of data. Some of this data is often written, by a direct memory access process, into memory 840 during execution of software in the computer system 800. One of skill in the art will immediately recognize that the terms “machine-readable medium” or “computer-readable medium” includes any type of storage device that is accessible by the processor 810 and also encompasses a carrier wave that encodes a data signal.

The computer system 800 is one example of many possible computer systems which have different architectures. For example, personal computers based on an Intel microprocessor often have multiple buses, one of which can be an input/output (I/O) bus for the peripherals and one that directly connects the processor 810 and the memory 840 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 840 for execution by the processor 810. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 800 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Linux operating system and its associated file management system. The file management system is typically stored in the non-volatile storage 850 and causes the processor 810 to execute the various acts required by the operating system to input and output data and to store data in memory, including storing files on the non-volatile storage 850.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-roms, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

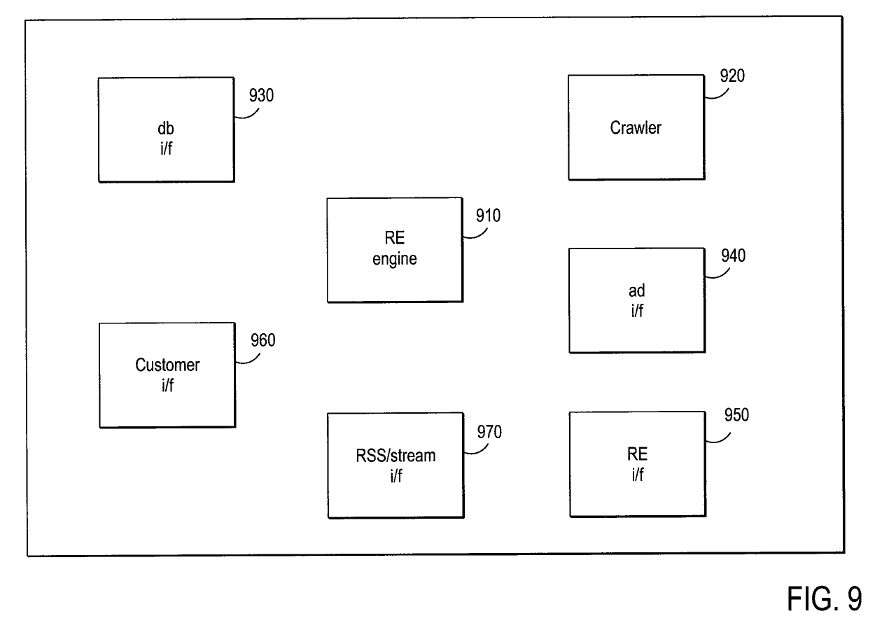

A machine-readable medium may be used in conjunction with a real estate portal. FIG. 9 illustrates an embodiment of a medium embodying modules of a real estate portal. Medium 900 includes a real estate engine, crawler, database interface, advertising interface, real estate submission interface, customer interface, and an RSS/stream interface. Alternative implementations may include some or all of these components.

Real estate engine 910 may operate a portal, receiving data and requests, and displaying data corresponding to requests. Crawler 920 may be a robotic web crawler which seeks out listing data from various websites. Database interface 930 may allow for storage of listing data and related data for real estate engine 910.

Advertising interface 940 may accept requests for advertisements. These requests may include criteria for an advertisement and an amount of a bid. Similarly, real estate submissions interface 950 may accept submissions of listing information from agents or agencies, for example, providing an additional and potentially early or more accurate source of information. Customer interface 960 may provide the general user interface for the site, allowing for searches for real estate listing and related information, for example. RSS/stream interface 970 provides an interface for RSS or HTML data streams, for example, of data from real estate engine 910 and an associated portal.

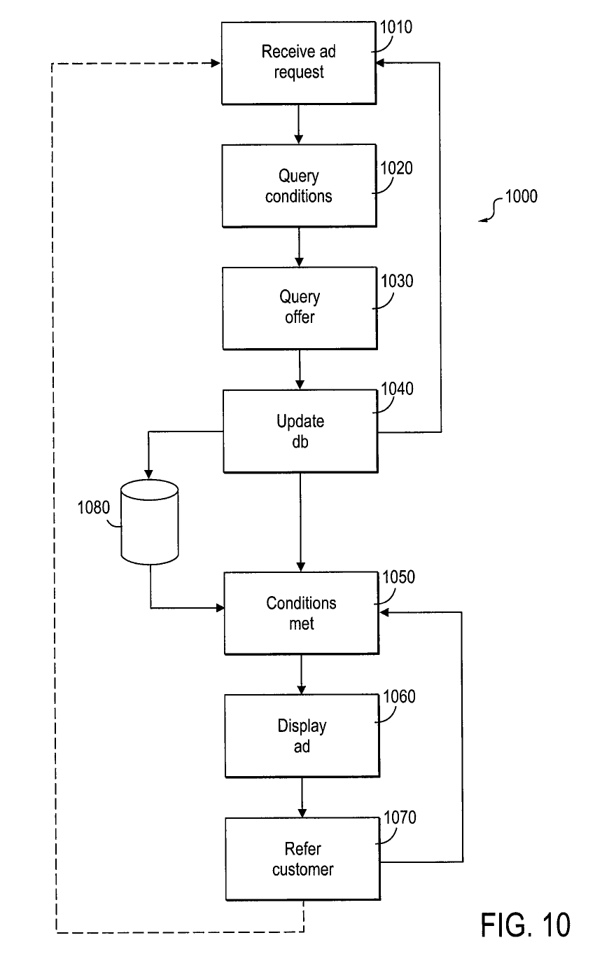

A method of receiving and using advertising information may be useful alongside the general methods of operating the portal. FIG. 10 illustrates an embodiment of a method of operating advertising on a real estate portal. Method 1000 includes receiving an advertising request, querying the requester for specific information, updating a database, determining that advertising conditions are met, displaying the advertisement, and referring a customer to the advertiser.

Method 1000 initiates with receipt of an advertising request at module 1010. The advertiser is asked for conditions for the advertisement, such as geographic location, size of house, etc. at module 1020. At module 1030, a bid is requested from the advertiser. This may result in letting the advertiser know whether this is a winning bid at the time or not. The advertising information is then submitted to a database 1080.

When conditions are met for an advertisement, the database 1080 will return that advertisement responsive to a query for advertisements meeting a set of criteria. Thus, a request for a listing with a price of $1.3 million in Palo Alto will trigger an advertisement setting criteria of a price of at least $1 million in Palo Alto. A resulting advertisement is displayed at module 1060, and a customer may be referred at module 1070 based on click he advertisement or display of the advertisement, for example.

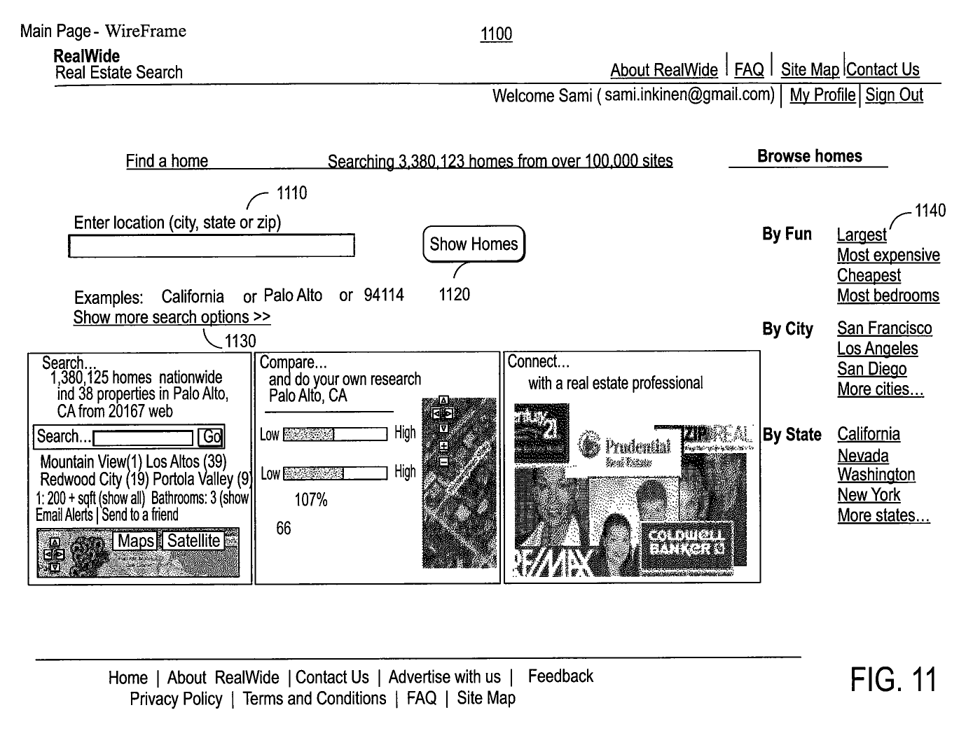

The following embodiment represents a set of user interfaces which may be useful with the methods and systems described above. FIG. 11 illustrates an embodiment of a search page of a real estate portal. User interface 1100 provides a webpage which may be used by a user to search for real estate listings. Location entry box 1110 allows for description of a location for searching for real estate listings. Show homes button 1120 triggers the search based on the contents of box 1110. Options link 1130 provides a link to a more detailed set of search options. Browse links 1140 provide a set of links to essentially preset searches which may be based on a variety of considerations. These searches as illustrated include searches by city, by state, and by characteristics such as largest, most expensive, or cheapest, for example.

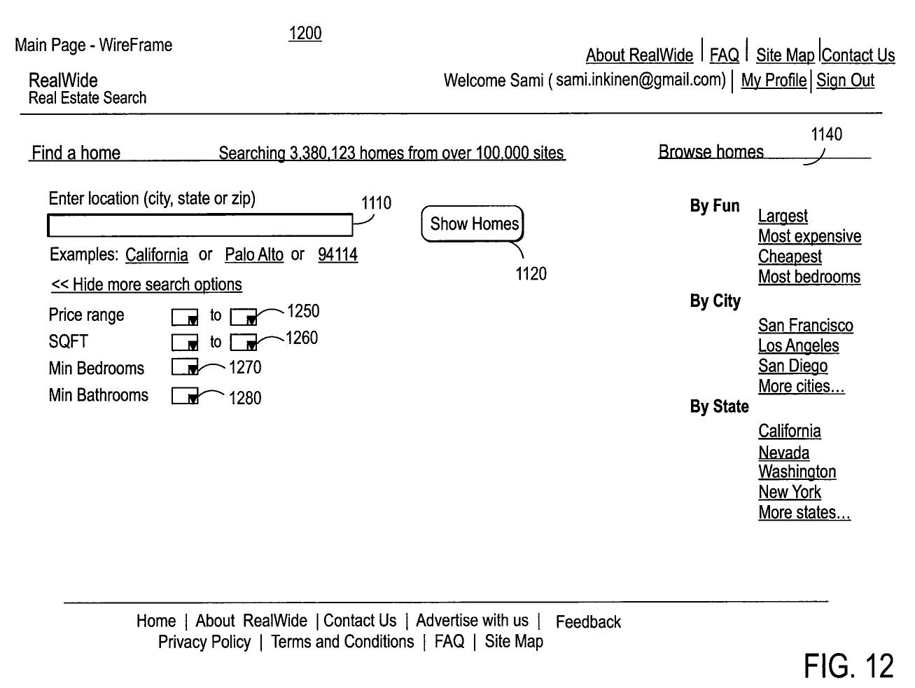

FIG. 12 illustrates an alternate embodiment of a search page of a real estate portal. User interface 1200 provides the features of user interface 1100, along with expanded search capabilities. Price range selection 1250 allows for selection of a low and high price for a listing. SQFT selection 1260 allows for selection of minimum and maximum square feet in a property. Min bedrooms 1270 allows for a minimum number of bedrooms, and min bathrooms 1280 similarly allows for a minimum number of bathrooms.

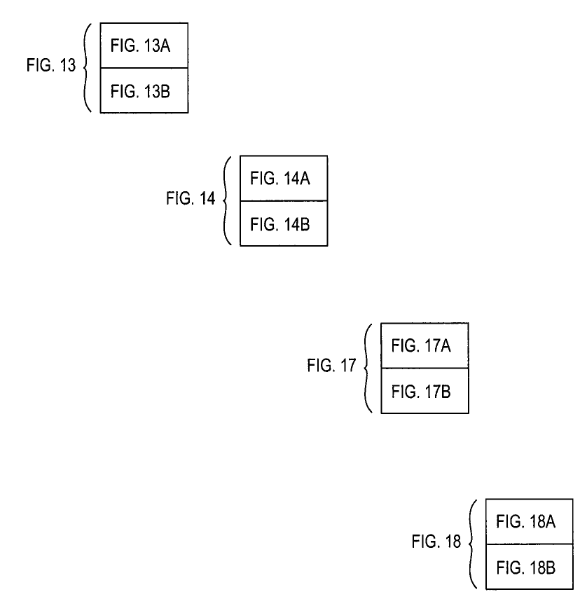

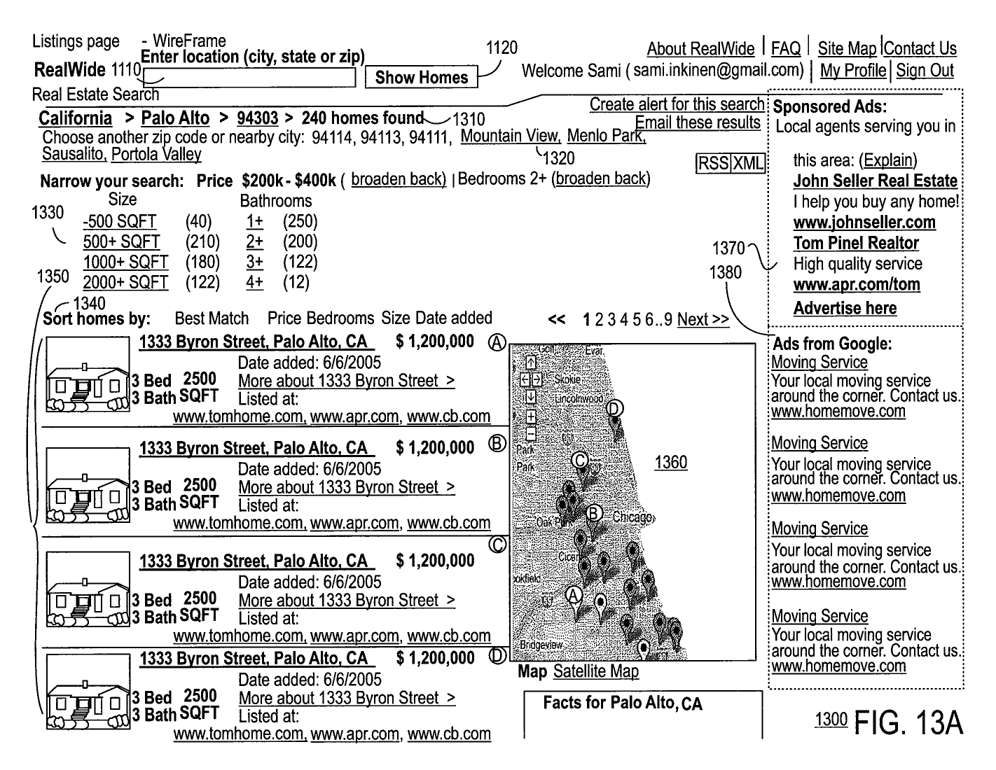

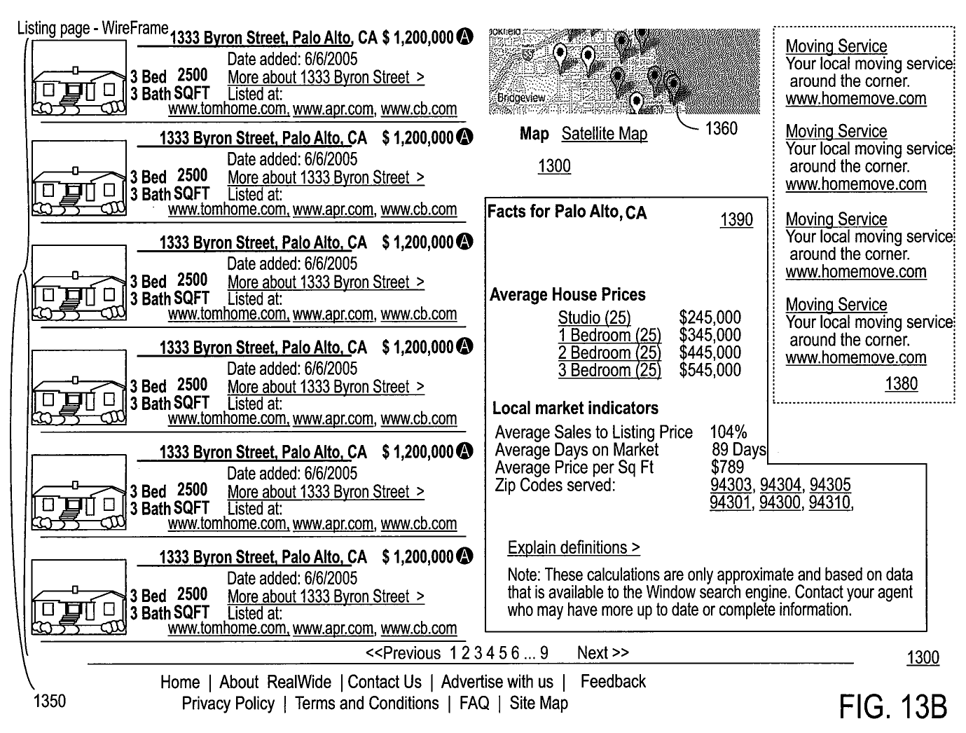

When a search is submitted, a resulting page displays a number of properties. FIG. 13A and 13B illustrate an embodiment of a display of property search results. User interface 1300 provides a view of various different properties in a number of forms, along with related information. Referring to FIG. 13A, the basic search tools 1110 and 1120 are still displayed. However, the user interface 1300 also includes a location and result 1310, a set of nearby locations 1320 with links to trigger searches of these nearby locations, and narrowing parameters 1330—a set of links to searches with a more restrictive search and a quantity of listings fitting each search.

User interface 1300 also provides detailed results in terms of home listings 1350 which is a series of capsule listings of homes. Also provided is sorting bar 1340 which allows for resorting of the home listings 1350 based on various factors. Additionally, map 1360 is provided with a graphical representation of locations of the results. Moreover, sponsored advertisements 1370 (the cost-per-click advertisements) and ads from a search engine 1380 are also displayed. Referring to FIG. 13B, the rest of the home listings 1350 for the page are displayed. Also provided are facts about the location selected (local facts 1390). FIGS. 13A and 13B provide a single page as FIG. 13.

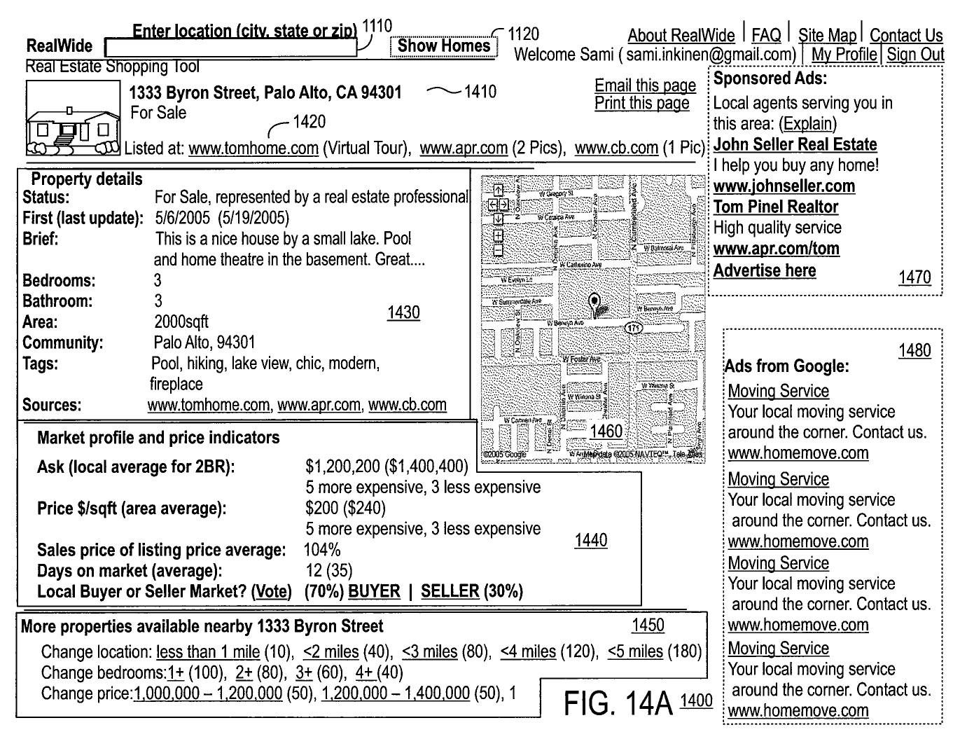

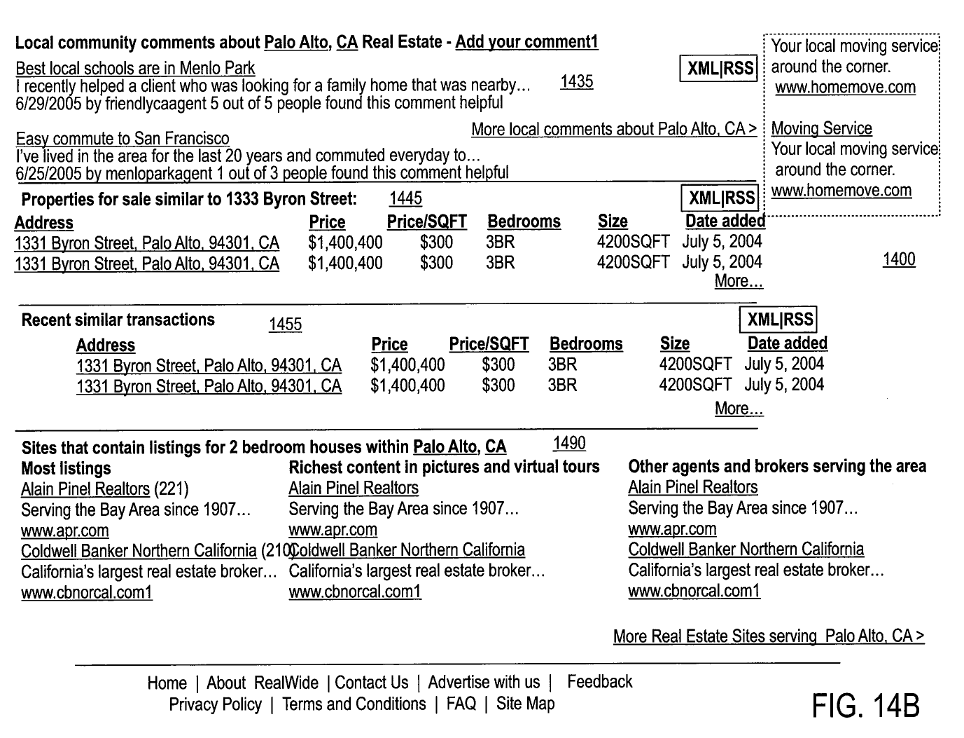

Selecting a single entry leads to a more specific display for that entry. FIG. 14A and 14B illustrate an embodiment of a display of single property information. User interface 1400 (as illustrated in FIG. 14A) provides a location listing 1410, website references 1420, and property details 1430, all of which may be gleaned from other web-based listings. Also provided is market profile 1440, which includes information about the local area, map 1460 (of the location) and nearby properties 1450 (additional properties on the market in the same general area). Moreover, paid advertisements 1470 and advertisements from a search engine 1480 are also provided. The user interface 1400 scrolls down into FIG. 14B to illustrate local community comments 1435, similar properties 1445, and recent sales 1455. Also provided are real estate websites with related content 1490.

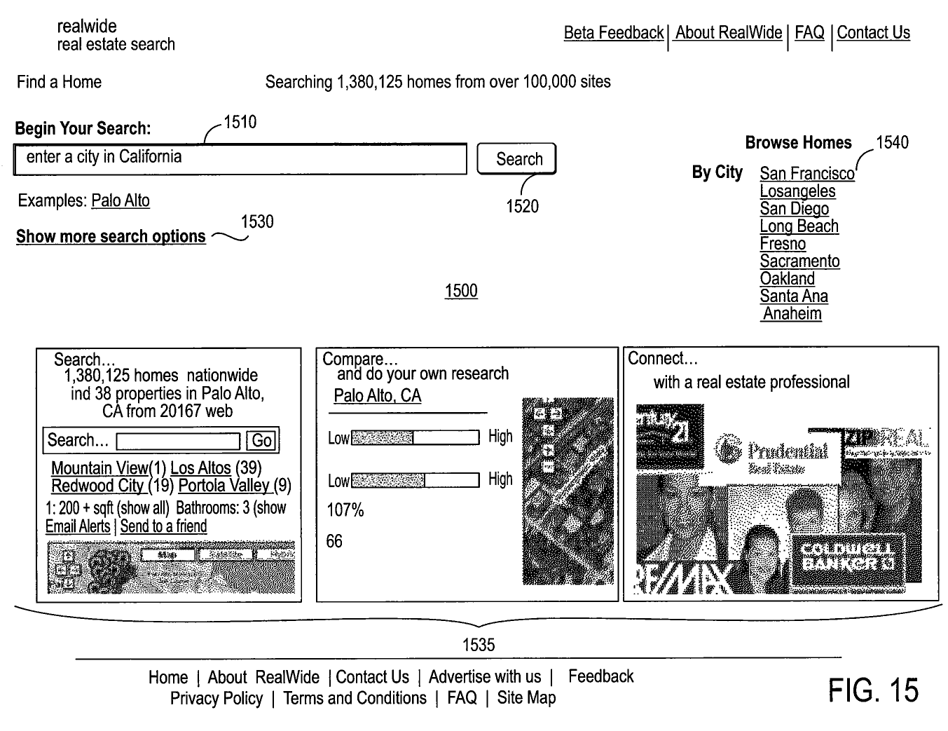

FIG. 15 illustrates another embodiment of a search page of a real estate portal. User interface 1500 provides a webpage which may be used by a consumer to search for real estate listings, for example. Location entry box 1510 providesfor submission of a location for searching for real estate listings. Such a location may be a city or other municipal entity, a street, an address, or some other geographically identifying information. Search button 1520 triggers a search based on the contents of box 1510.

Options link 1530 provides a link (or java applet) to a more detailed set of search options. Thus, search options may be expanded in some form of overlay, or a different search page may be accessed, for example. Browse links 1540 provide a set of links to essentially preset searches which may be based on a variety of considerations. These searches, as illustrated, include searches by city, and can include searches by characteristics such as largest, most expensive, cheapest, or large geographical region (e.g. state), for example. Graphic links 1535 provide links to other options within the portal, such as comparing properties and connecting with a real estate professional.

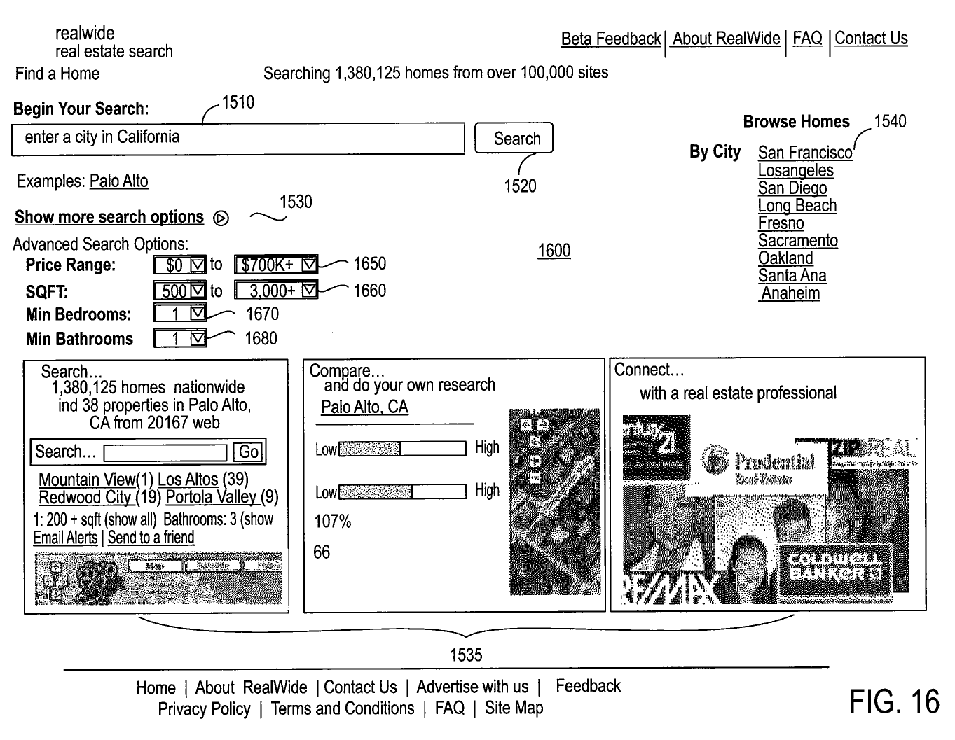

FIG. 16 illustrates another alternate embodiment of a search page of a real estate portal. User interface 1500, as modified, provides expanded search capabilities. Price range selection 1650 provides for selection of a low and/or high price for a listing. SQFT selection 1660 provides for selection of minimum and maximum square feet in a property (typically internal residential area). Min bedrooms 1670 provides for a minimum number of bedrooms, and min bathrooms 1680 similarly provides for a minimum number of bathrooms. Similar maximum fields may also be provided, and many other features may be provided for searching or sorting.

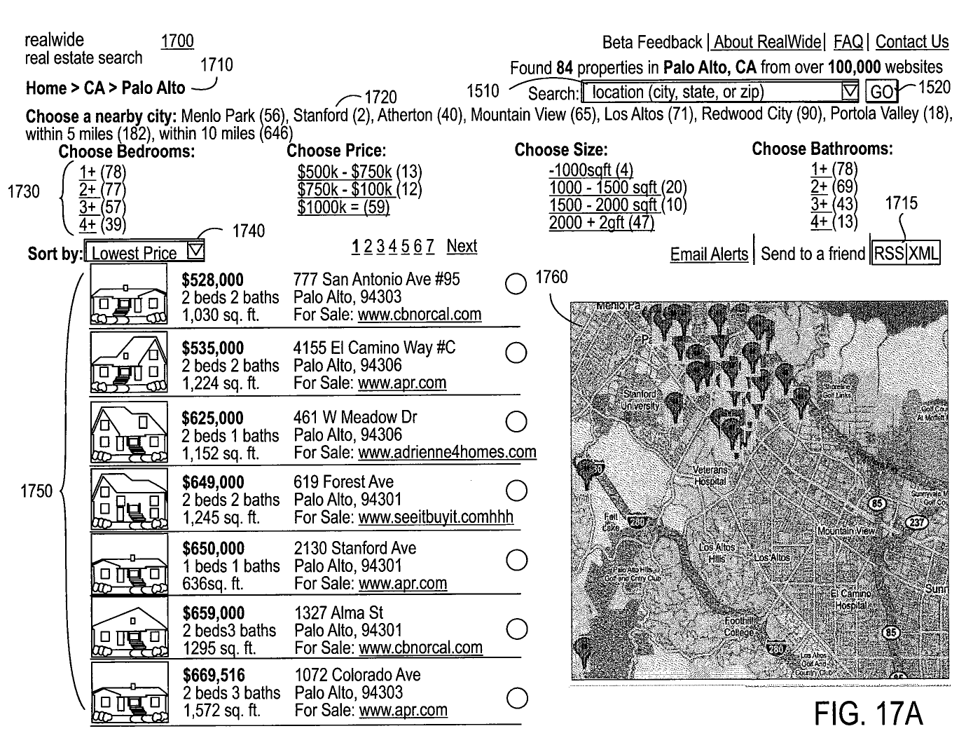

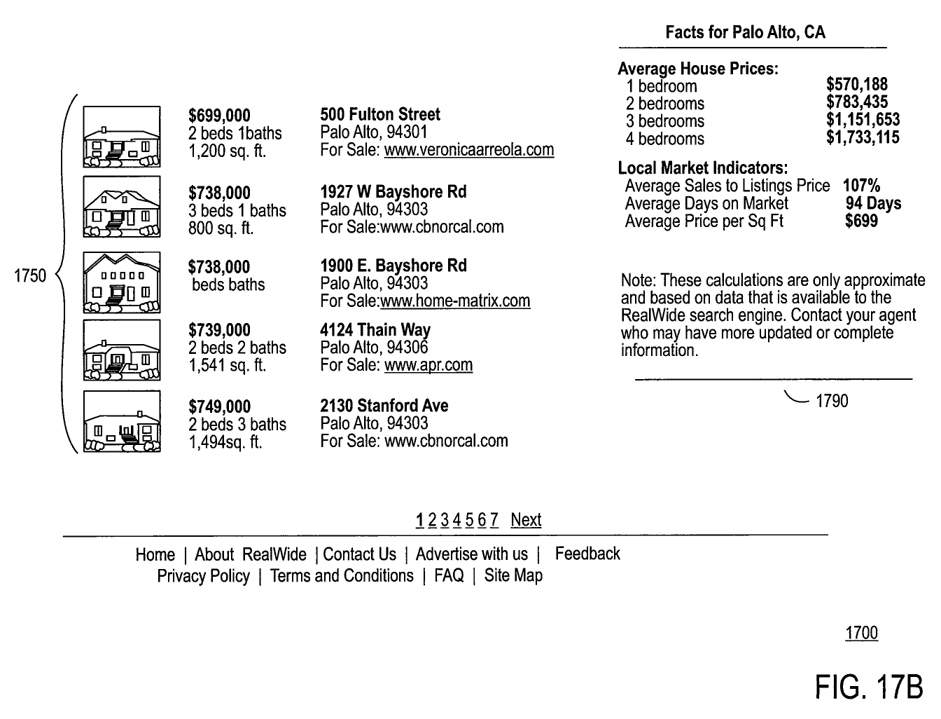

FIGS. 17A and 17B illustrate another embodiment of a display of property search results. FIGS. 17A and 17B provide a single page as FIG. 17. User interface 1700 provides a view of various different properties in a number of forms, along with related information. Referring to FIG. 17A, the basic search tools 1510 and 1520 are still displayed, and an RSS/stream link 1715 is provided. The user interface 1700 also includes a general location (town for example) and result 1710, a set of nearby locations 1720 with links to trigger searches of these nearby locations, and narrowing parameters 1730—a set of links to searches with a more restrictive set of parameters and a quantity of listings fitting each search.

User interface 1700 also provides detailed results in terms of home listings 1750 which is a series of capsule listings of homes. Also provided is sorting selection box 1740 which allows for resorting of the home listings 1750 based on various factors. Additionally, map 1760 is provided with a graphical representation of locations of the results. Map 1760 may be derived from a popular map website, such as Google Maps or Mapquest, for example. Moreover, advertisements of various forms may also be displayed. Referring to FIG. 17B, the rest of the home listings 1750 for the page are displayed. Also provided are facts about the location selected (local facts 1790).

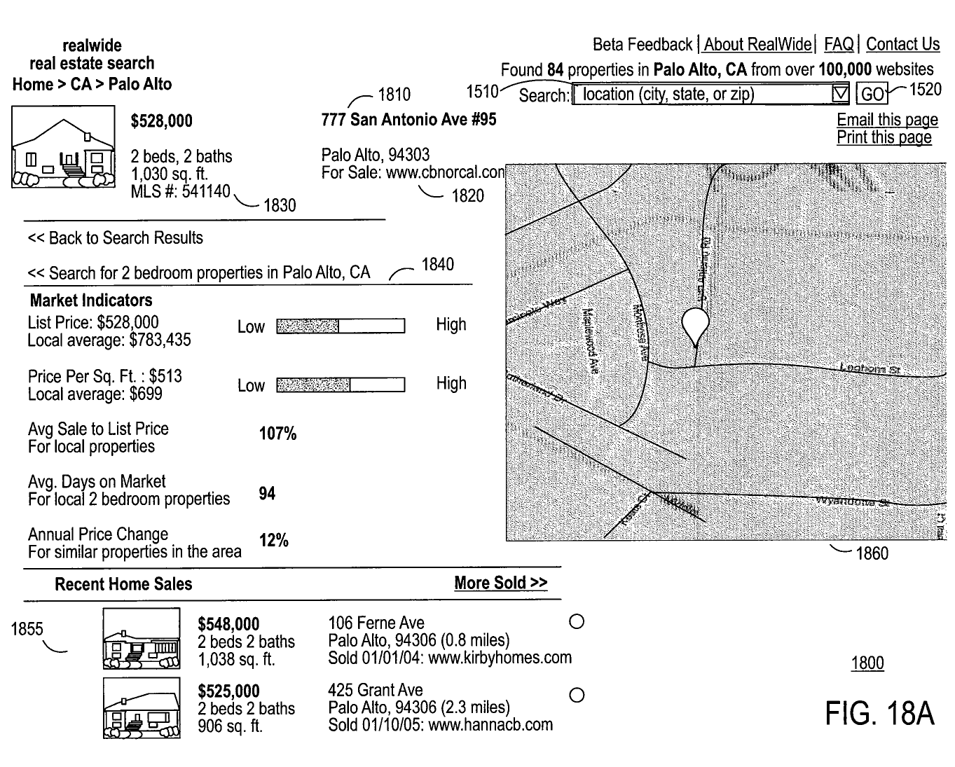

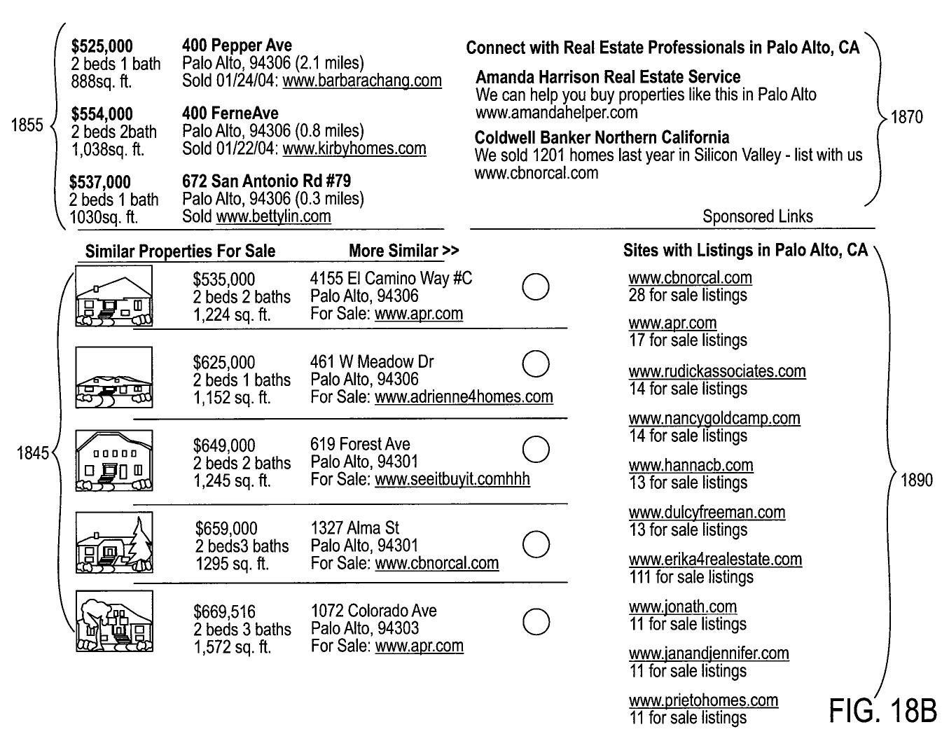

FIG. 18A and 18B illustrate another embodiment of a display of single property information. FIGS. 18A and 18B provide a single page as FIG. 18. User interface 1800 (as illustrated in FIG. 18A) provides a location listing 1810, website references 1820 (where the property is listed on the web), and property details 1830, all of which may be gleaned from other web-based listings. Also provided is market profile 1840, which includes information about the local area, map 1860 (of the location) and recent home sales 1855 (properties recently sold in the same general area, generally with similar characteristics). The user interface 1800 scrolls down into FIG. 18B to illustrate similar listed properties 1845. Also, paid advertisements 1870 (the cost-per-click advertisements, for example) are provided. Additionally, real estate websites with local content 1890 are provided.

Features and aspects of various embodiments may be integrated into other embodiments, and embodiments illustrated in this document may be implemented without all of the features or aspects illustrated or described. One skilled in the art will appreciate that although specific examples and embodiments of the system and methods have been described for purposes of illustration, various modifications can be made. For example, embodiments of the present invention may be applied to many different types of databases, systems and application programs. Moreover, features of one embodiment may be incorporated into other embodiments, even where those features are not described together in a single embodiment within the present document.

What is claimed is:

1. A method, comprising:
Receiving real estate listings by submission at a website;
Searching for real estate listings on the world wide web;
Receiving a search query from a user at a user website;
and
Presenting real estate listings responsive to the search query on the user website.

2. The method of claim 1, further comprising:
Receiving real estate listings through a feed.

3. The method of claim 1, further comprising:
Receiving advertising submissions at a website; and
Presenting advertising submissions related to the search query on the user website.

4. The method of claim 3, further comprising:
Monetizing advertising submissions.

5. The method of claim 3, wherein:
Advertising submissions include an offer of a payment amount.

6. The method of claim 3, wherein:
Advertising submissions include conditions under which an advertisement may be presented.

7. The method of claim 3, further comprising:
Referring a customer to a designated website through the advertisement.

8. The method of claim 3, wherein:
Advertising submissions advertise at least one of a real estate service provider, a real estate brokerage agency, or a real estate broker;

9. The method of claim 1, wherein:
Real estate listings include listings from real estate for sale by an owner of the real estate.

10. The method of claim 1, wherein:
Real estate listings include listings from real estate offered for sale through a broker.

11. The method of claim 1, wherein:
Real estate listings include listings from real estate offered for sale through a brokerage agency.

12. The method of claim 1, wherein:
Real estate listings include listings provided through a multiple listing service.

13. The method of claim 1, wherein:
Real estate listings include listings from real estate for sale by an owner of the real estate, from real estate offered for sale through a broker, from real estate offered for sale through a brokerage agency, and listings provided through a multiple listing service.

14. A system, comprising:
a computer;
the computer having a network interface;
the computer having a user interface;
the computer to:
receive real estate listings by submission at a website;
search for real estate listings on the world wide web;
receive a search query from a user at a user website;
and present real estate listings responsive to the search query on the user website.

15. The system of claim 14, wherein:
the computer is further to:
receive advertising submissions at a website;
and
present advertising submissions related to the search query on the user website.

16. The system of claim 14, wherein:
the computer is further to:
receive real estate listings through a feed.

17. The system of claim 14, further comprising:
means for storing the real estate submissions.

18. A machine-readable medium embodying instructions, the instructions, when executed by a processor, causing the processor to implement a method, the method comprising:
Receiving real estate listings by submission at a website;
Receiving real estate listings through a feed;
Searching for real estate listings on the world wide web;
Receiving a search query from a user at a user website;
and
Presenting real estate listings responsive to the search query on the user website.

19. The medium of claim 18, wherein the method further comprises:
Receiving advertising submissions at a website;
Monetizing advertising submissions;
and
Presenting advertising submissions related to the search query on the user website.

20. The medium of claim 19, wherein the method further comprises:
Referring a customer to a designated website through the advertisement.
